(19) United States
(12) Patent Application Publication
(10) Pub. No.: US 2002/0094783 A1
(43) Pub. Date: Jul. 18, 2002

(54) Space shift keying modulation

(76) Inventors: Yawgeng Chau, Taipei Hsien (TW); Shi-Hon Yu, Hua-Lien City (TW)

Correspondence Address: Yawgeng Chau, P.O. Box 82-144, Taipei, TW

(21) Appl. No.: 09/985,988

(22) Filed: Nov. 7, 2001

(30) Foreign Application Priority Data
Nov. 28, 2000 (TW) 089125273

(51) Int. Cl. H04B 17/00

(52) U.S. Cl. 455/67.1; 455/67.3; 455/67.4

(57) ABSTRACT

A space shift keying (SSK) modulation is disclosed. At the transmitter of a digital wireless communication with an antenna array, due to the fact that multipath fading will cause different responses for distinct array elements, different information signal bits (such as the “0” and “1” in binary shift keying) can be sent from different array elements to the receiver site. At the receiver site, the likelihood ratio test can be used to recognize the information signal bits transmitted from different array elements. The present signaling method for carrying information signal bits is a digital modulation method, which is known as space shift keying modulation.

### BACKGROUND OF THE INVENTION

(a) Technical Field of the Invention

The present invention relates to space shift keying modulation (SSK), and in particular, to a digital modulation technique for carrying information signals.

(b) Description of the Prior Art

As a result of fast development of technologies, the needs of information in daily life has greatly increased, both in audio-video signal transmission or the transmission of data signal. Thus the data rate of transmitter has become an important indicator in evaluating the performance of the transmitter.

The space shift keying modulation of the present invention employs the statistical properties of space wireless channel with respect to distinct positions of the antenna elements. The present method is different from that of the conventional modulation, such as binary phase shift keying (BPSK) modulation, binary frequency shift keying (BFSK), and binary amplitude shift keying (BASK) modulation. In the present space shift keying (SSK) modulation, the number of wireless transmission statistical properties of distinct antennas at the emitter site are different and the present modulation can be combined together with the conventional digital modulation technique so as to increase modulation level to obtain high speed data transmission. By using the present method, the level of the conventional digital modulation methods has not been increased, therefore the quality of transmission can be maintained and the bit error rate is within a required range.

### SUMMARY OF THE INVENTION

Accordingly, it is an object of the present invention to provide space shift keying modulation, wherein a binary SSK (i.e., “0” and “1”) modulation is employed, and the method of modulation is as follows:

a. inputting binary information signals;

b. transmitting the signals through the upper L antennas of the receiver circuit if the information signal bit is “1”; transmitting the signals through the lower single antenna of the receiver circuit if the information signal bit is “0”;

c. up-converting the signal from low frequency into to RF band by passing through a band pass filter;

d. transmitting different signals, “0” and “1” by different elements and numbers of antennas; and

e. performing likelihood ratio test to demodulate and detect the transmitted bits.

Yet another object of the present in invention is to provide space shift keying modulation, wherein the present method can be employed in various types of wireless communication systems, such as mobile communication system, wireless regional network, etc.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing binary space shift keying modulation system in accordance with the present information.

FIG. 2 is a graph showing the numerical results of performance evaluation using the BSSK modulation in accordance with the present invention.

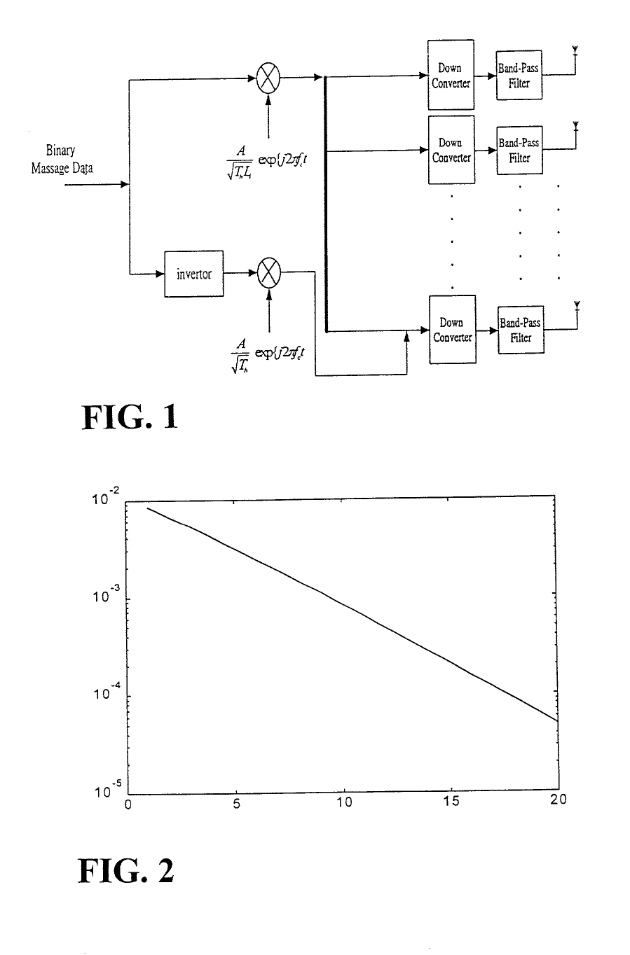

### DETAILED DESCRIPTION OF THE PREFERRED EMBODIMENT

For the purpose of promoting an understanding of the principles of the invention, reference will now be made to the embodiment illustrated in the drawings. Specific language will be used to describe the same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

In accordance with the present invention, distinct antenna elements are employed in the wireless communication system for transmission to produce digital transmission signals. Thus, any conventional digital modulation technique can be combined to upgrade data transmission rate. For instance, digital phase shift keying (Digital PSK), digital frequency shift keying (Digital FSK). For the convenience of description of the present invention the single, binary space shift keying (SSK) modulation is described.

Binary space shift keying modulation refers to employing of distinct fading statistical properties of wireless path in space with respect to different antenna elements to carry binary signal. In conventional binary modulation system, signals are carried in phase, frequency, or amplitude, for instance, BPSK modulation, BFSK modulation, or BASK modulation. The BSSK modulation employs distinct elements and numbers of antennas, thereof to carry “0” and “1” information signal bits, and thus in the present BSSK technique, the frequency and phase of the transmission signal can be fixed. In accordance with the present invention, the method of BSSK and the mathematical model with L antennas at the transmitter site and one single antenna at the receiver site are explained as follows:

s₀(t): the transmitted signal from one single antenna at the transmitter site when the transmitting bit is “0”;

s_{1,l}(t): the transmitted signal from the 1-th antenna of the array antenna at the transmitter site when the transmitting bit is “1”;

r₀(t): the received signal at the receiver site when the transmitting bit is “0”;

r₁(t): the received signal at the receiver site when the transmitting bit is “1”;

ƒ_{c}: the carrier frequency of the transmitted signal;

A: the amplitude of the transmitted signal;

T_{b}: the bit during of the transmitted signal;

αᵢ: the magnitude of channel fading factor from the i-th transmitter antenna to the receiver antenna, wherein i=1, 2, 3, . . . L;

θᵢ: the phase of the channel fading factor from the i-th transmitter antenna to the receiver antenna, wherein i=1, 2, 3, . . . L;

mₗ: the mean of the channel fading factor from the i-th transmitter antenna to the receiver antenna, wherein the mean is in a complex format;

Ω: the variance in the probability density function of the channel fading factor;

nⱼ(t): the channel noise of the signal received by the antenna of the receiver.

(1) The mathematical model of the transmitted signal

If the transmitted bit is “0”, the transmitted signal is

$${s}_{0} ( t ) = \frac{A}{\sqrt{{T}_{b}}} exp \{ j2 π {f}_{c} t \}$$

If the transmitted bit is “1”, the transmitted signal of the 1-th transmitting antenna is

$${s}_{1 , l} ( t ) = \frac{A}{\sqrt{L {T}_{b}}} exp \{ j2 π {f}_{c} t \}$$

In view of the above, if bit “0” is to be sent by the transmitter, a single antenna is used. On the other hand, if bit “1” is to be sent by the transmitter, L antennas have to be employed. Accordingly, the present invention makes use of wireless channel statistical properties of the distinct antennas in space to provide the modulation. In other words, information signals carried by different numbers of space antennas to transmit different information signal bits, where the distinct wireless channels with distinct fading statistical properties are used to discriminate information signals.

(2) Format of the received signal at the receiver site

The mathematical model of received signal via the fading channel from the transmitted BSSK signal is as follows:

When the transmitted bit is “0”, the signal received at the receiver site is

$${r}_{0} ( t ) = \frac{A}{\sqrt{{T}_{b}}} {α}_{1} exp \{ j {θ}_{1} \} exp \{ j2 π {f}_{c} t \} + n ( t )$$

when the transmitted bit is “1”, the signal received at the receiver site is

$$\begin{matrix}{r}_{1} ( t ) = \frac{A}{\sqrt{L {T}_{b}}} ( {α}_{1} exp \{ j {θ}_{1} \} + Λ + {α}_{L} exp \{ j {θ}_{L} \} ) exp \{ j2 π {f}_{c} t \} + n ( t ) \\ = \frac{A}{\sqrt{L {T}_{b}}} {\sum }_{i = 1}^{L} {α}_{i} exp \{ j {θ}_{i} \} exp \{ j2 π {f}_{c} t \} + n ( t )\end{matrix}$$

where in r₁ (t), if L antennas are used at the transmitter site, the receiver will receive the summation of all the transmitted signals.

In view of the received signal format and by using the Maximum Likelihood Ratio Test, the optimum receiver can be designed.

(3) Analysis of the preferred embodiment

The analysis results are based on the following parameters:

Lₜ=2

Lᵣ=1

m₁₁=1+j

m₂₁=2+j2

Ω=3

T_{b}=1

NoisePower=N₀/2

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of space shift keying modulation using a digital wireless communication system with a transmitter, receiver and an antenna array comprising the steps of transmitting different information signal bits (the “0” and “1” in the binary shift keying) from different antenna elements to the receiver; and detecting the information signal bits transmitted from different elements and numbers of transmitter antennas by the Likelihood Ratio Test.

2. The method of space shift keying of claim 1, further comprising the step of (c) employing a plurality of antenna to carry the transmitted information signals.

3. The method of space shift keying of claim 1, wherein the method is employed in the transmission using the modulation of multiple-bit or M-ary information signals.
